(19) United States
(12) Patent Application Publication
(10) Pub. No.: US 2002/0180325 A1
(43) Pub. Date: Dec. 5, 2002

(54) Light beam guiding device for head lights of cars

(76) Inventor: Sen-Yung Lee, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/873,198

(22) Filed: Jun. 5, 2001

(51) Int. Cl. H01J 5/16

(52) U.S. Cl. 313/113

(57) ABSTRACT

A head light includes a curve refection base and a filament is connected to a close end of the reflection base, and a transparent casing is connected to an open end of the reflection base. A light beam guiding device is connected to an inside of the casing and includes a plurality of plates. Each plate has an absorbing layer coated on an upper surface thereof, and a reflection layer coated on a bottom surface of each of the plates. The light beam is not reflected upward and is reflected downward.

### FIELD OF THE INVENTION

The present invention relates to a light beam guiding device received in a head light of cars and includes plurality of plates. Each plate has a upper absorbing coating and a bottom reflection coating so as to reduce light going upward and increase light reflected downward.

### BACKGROUND OF THE INVENTION

A conventional head light for cars is shown in FIG. 1 and generally includes a curve reflection base “b” with a filament connected thereto, a hood “a” is located in upper front of the filament so as to reduce the light going upward, and a casing which is connected to the reflection base “b” to form an enclosed space. A plurality of protrusions extend inward from an inner side of the casing and include many horizontal surfaces “c” which reflect the light downward to illuminate the ground in front of the cars and widen the range that the light reaches. However, the reflection base “b” is not a perfect parabola surface because the limitation of space in the frame of the car and the filament is not a spot or a point located at the focus of the desired position, so that there are many plan surfaces on the reflection base “b”, and the upward light reflected by the reflection base “b” cannot be completely obscured by the hood “a”. Therefore, the light goes upward will goes to the drivers eyes of coming cars and could form a light screen especially when in foggy or rainy days.

The present invention intends to provide a light guiding device that effectively guides the light to go downward and the upward light is absorbed by the absorbing layers on the device.

### SUMMARY OF THE INVENTION

In accordance with one aspect of the present invention, there is provided a head light which comprises a curve refection base and a filament is connected to a close end of the reflection base. A casing is connected to an open end of the reflection base. A light beam guiding device is connected to an inside of the casing and includes a plurality of plates. Each plate has an absorbing layer coated on an upper surface thereof, and a reflection layer coated on a bottom surface of each of the plates.

The primary object of the present invention is to provide a light beam guiding device which eliminates light beams to be reflected upward and guides light beams to go downward.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show a conventional head light;

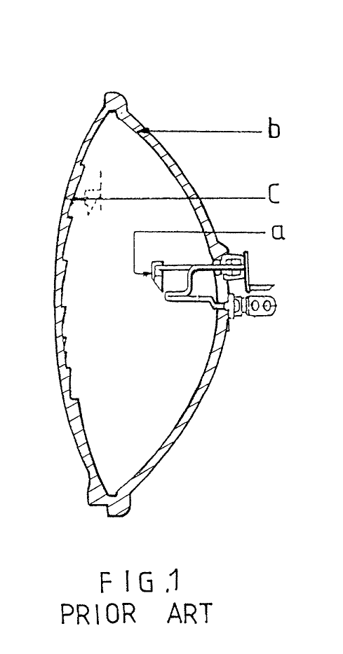

FIG. 2 is an exploded view to show a head light with a light beam guiding device of the present invention;

FIG. 3 is a side view to show each plate of the light beam guiding device of the present invention, and

FIG. 4 is a cross sectional view to show the head light with the light beam guiding device of the present invention.

### DETAILED DESCRIPTION OF THE PREFERRED EMBODIMENT

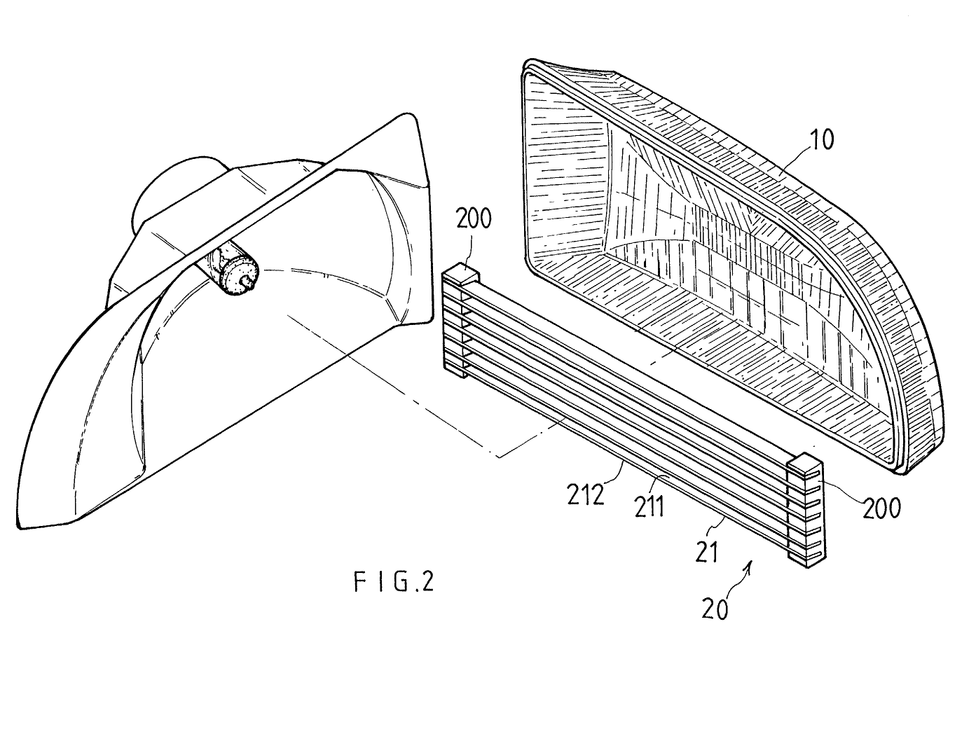

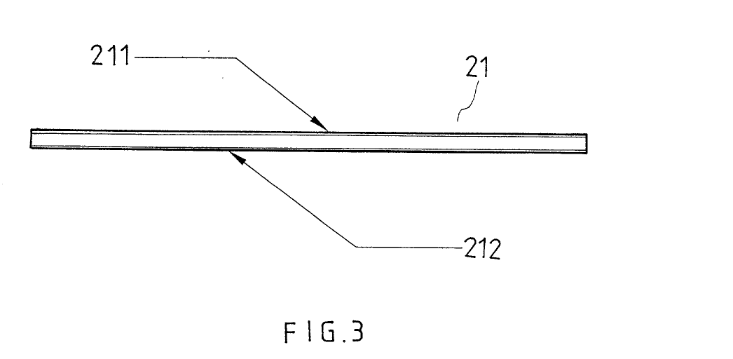

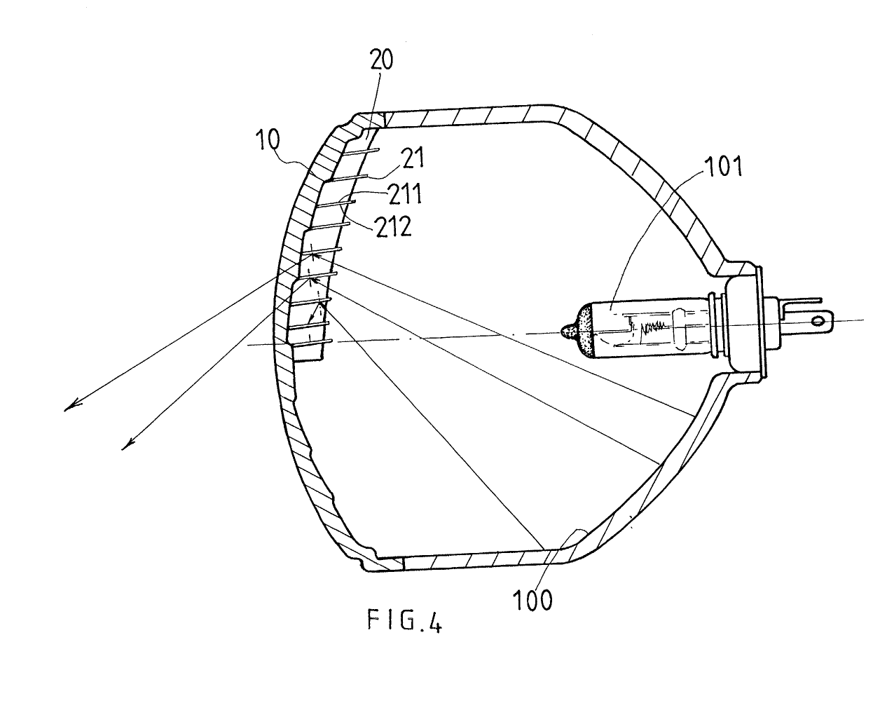

Referring to FIGS. 2 to 4, the head light of the present invention comprises a curve refection base 100 and a filament 101 is connected to an inside of a close end of the reflection base 100. A transparent casing 10 is connected to an open end of the reflection base 100 so that light beam reflected from the reflection base 100 goes through the casing 10.

A light beam guiding device 20 is connected to an inside of the top half of the casing 10. The light beam guiding device 20 includes two posts 200 and each post 200 has a plurality of slits defined therein. A plurality of plates 21 are respectively engaged with the slits in the two posts 200. Each plate 21 has an absorbing layer 211 coated on an upper surface thereof, and a reflection layer 212 coated on a bottom surface of each of the plates 21. The angle of the plates 21 relative to the horizon can be arranged as desired according to different needs of the head lights. The light beams on the upper surfaces of the plates 21 can be absorbed by the absorbing layers 211 so that the light beams will not go upward. The light beams are reflected by the reflection layers 212 of the plates 21 so as to increase the illumination on the ground in front of the cars.

By this light beam guiding device 20, the head light generates no upward light toward the drivers' eyes of coming cars and effectively illuminates the ground. The head lights needs no extra visors attached on the outside of the casing 10 and the width of each of the plates 21 can be made to meet different requirements and purposes of different head lights.

While we have shown and described the embodiment in accordance with the present invention, it should be clear to those skilled in the art that further embodiments may be made without departing from the scope of the present invention.

What is claimed is:

1. A head light comprising:
a curve refection base and a filament connected to an inside of a close end of the reflection base, a casing connected to an open end of said reflection base, and
a light beam guiding device connected to an inside of said casing and including a plurality of plates, each plate having an absorbing layer coated on an upper surface thereof, a reflection layer coated on a bottom surface of each of said plates.

2. The head light as claimed in claim 1 further comprising two posts and each post has a plurality of slits so that said plates being engaged with said slits.
